(19) United States
(12) Patent Application Publication
(10) Pub. No.: US 2006/0126827 A1
(43) Pub. Date: Jun. 15, 2006

(54) Encryption methods and apparatus

(75) Inventor: Dan P. Milleville, Ayer, MA (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: Dan P. Milleville, Ayer, MA (US)

(21) Appl. No.: 11/011,993

(22) Filed: Dec. 14, 2004

(51) Int. Cl. H04L 9/28

(52) U.S. Cl. 380/28

(57) ABSTRACT

An encryption and decryption system is provided. The system includes multiple sub-key tables, each sub-key table associated with an identifying number and multiple cipher engines arranged serially, each cipher engine capable of executing a different encryption operation on an input data stream using a sub-key table and producing an output data stream. The system also includes a number generator for generating numbers used to select sub-key tables. Data that assist deciphering engines with deciphering text encrypted with the cipher engines is inserted into the output data stream of at least one of the multiple cipher engines. The ciphering portion of the system also includes a checksum engine positioned prior to the last cipher engine and adapted to produce a checksum value for insertion into the input data stream of the last cipher engine.

### CROSS-REFERENCE TO RELATED APPLICATIONS

Not applicable.

### STATEMENT REGARDING FEDERALLY SPONSORED RESEARCH

Not Applicable.

### FIELD OF THE INVENTION

The present invention relates to encryption systems, and in particular to encryption system that provide an increased level of security.

### BACKGROUND OF THE INVENTION

Cipher technology has been advancing over the years in complexity and security, however, attack algorithms have also advanced in step with the new cipher technology. No matter how complex the cipher technology has become, when the stakes are high enough, someone, somehow seems to manage, or eventually will manage (given advances in computer and/or break algorithm technology) to develop new ways of breaking a cipher. Take the DES cipher for example; it is no longer a safe encryption system due to advances in breaking technology.

The authors of other ciphers similarly state that even with advances in technology, their ciphers cannot be broken in anyone's lifetime. The problem with that statement is that it assumes the attacker will use the breaking technologies that either are known at this time or can reasonably be anticipated and does not consider the possibility that another totally unexpected technology, either in computer hardware or an as-yet-discovered unexpectedly efficient break algorithm, might be developed. For example, totally unexpected future technologies might cut many exponential magnitudes of time from the whole attack process, bringing the break process to a reasonable time span and rendering a once secure cipher vulnerable to attack. For example, when the DES was created, they estimated that it would take 120 years to break. Obviously, they did not take into account the unexpected advances in hardware and breaking technology because today, less than 30 later, it is broken. Likewise, we should not accept their current estimates that future efforts will fail to break conventional cipher systems.

Modem ciphers have vulnerabilities that may be exposed by future advances. For example, almost since the creation of the first cipher system, random numbers have been used to create the key tables used in ciphers. New cipher technologies have been developed that use pseudo random numbers (producing a predictable sequence of numbers) in the production of the encrypted text. Pseudo-random number generators need a seed number to produce a sequence of number. When used in an encryption system, this seed is also sent, generally with the encrypted text, to the decrypt cipher using a fixed encryption process. The legitimate receiver, using the same pseudo-random number generator, can then obtain the ‘seed’ from the ‘fixed’ encrypted text. When the seed is fed to the pseudo-random generator it produces the same sequence of random numbers that the encrypt cipher used to produce the encrypted text. The problem with this technology is that if an attacker obtains the ‘seed’ by breaking the ‘fixed’ algorithm portion of the message, and the attacker has the specific pseudo random number generator used by the cipher, the pseudo random generator in that cipher technology becomes useless. An attacker is able to use the seed number to determine the random numbers used for encryption and thereby compromise the supposedly protected text.

Accordingly, there is a need in the art for a more robust cipher that uses random numbers during the encryption process and does not rely on sending a seed number. This capability will withstand attacks from future technology by refusing to provide attackers with the starting seed.

### SUMMARY OF THE INVENTION

The system disclosed herein uses numerous key tables in a random sequence and thereby overcomes the inherent vulnerability of prior art single key or pseudo-random number multiple key cryptographic systems. In addition, the encryption system does not require transmitting information about the random numbers with a ‘fixed’ encryption process. As such, the random numbers in the present invention create an unpredictable moving target for attackers attempting to break this system. This overcomes the eventuality that someone will devise technology able to hit a fixed target (e.g., internal seed or single key table) no matter how small and/or complex the target is made. Even if someone were eventually able to break a single line, they would have to start the whole attack process again for the next line of data.

One embodiment of the cipher system disclosed herein provides an “envelope” methodology to connect multiple cipher engines using a non-pseudo or pseudo-random number generator in the production of the key tables and in the production of the encrypted text. The system uses two or more known cipher algorithms, along with a checksum algorithm and numbers from a pseudo or non-pseudo random number generator to produce encrypted text.

One exemplary cryptographic system comprises a key table divided into sections defining sub-key tables. Multiple cipher engines are arranged serially, with each cipher engine capable of executing a different encryption sequence on an input data stream using one randomly selected sub-key table from a structure of several sub-key tables. A non-pseudo or pseudo-random number is also obtained and used to randomly select the sub-key table for encrypting the next line of the input data stream and adds that selected number to an output data stream from one of the multiple cipher engines. The system also includes a checksum engine positioned in series prior to the last cipher engine capable of executing on the output data stream from the previous cipher engine and inserting a checksum value into the output data stream.

The sub-key for each engine and for each line (data segment) the engine performs its function on is chosen at random. For example, when the cipher system starts, it randomly selects which one of the (1,024) sub-key tables that are to be used for each cipher engine, the checksum engine, and overhead data insertion engine. The first cipher engine then executes and encrypts the first line of the input data. Before the output is provided to the next cipher engine, the next line's last cipher engine sub-key table number is randomly selected, and can be inserted in this data stream (using the overhead data insertion algorithm). The selected number is also stored for use in producing the next encrypted text line.

An intermediate cipher engine can then execute on the line using the cipher engine sub-key table randomly selected for that line. The checksum engine takes a mathematical snapshot of the output data stream from the intermediate cipher engine and calculates a checksum value. The checksum value(s) (using one, randomly selected, of the 1,024 checksum sub-keys) is then placed in the output data stream.

The last cipher engine, if not the second engine, executes on the data stream of the next-to-the-last cipher engine after the checksum has been inserted. The checksum string is thus encrypted along with the remainder of the data so that the output encrypted text line preferably does not contain any concatenated form of the checksum data string. The output of the last cipher engine is then transmitted or written to an output file as the encrypted text.

### BRIEF DESCRIPTION OF THE DRAWINGS

The invention can be more fully understood from the following detailed description taken in conjunction with the accompanying drawings, in which:

FIG. 1A is a diagram of one embodiment of the encryption system of the present invention including three encryption engines;

FIG. 1B is a diagram of another embodiment of the encryption system of the present invention including two encryption engines; and

FIG. 2 is a diagram of one embodiment of the decryption system of the present invention including three encryption engines.

### DETAILED DESCRIPTION OF THE INVENTION

The present invention provides encryption systems with an increased level of security. In one exemplary embodiment, the encryption system comprises multiple sub-key tables, each sub-key table associated with an identifying number, and multiple cipher engines arranged serially, each cipher engine is capable of executing a different encryption process on an input data stream using a sub-key table to produce an output data stream. The system additionally includes an overhead data inserter for inserting deciphering data into the output data stream of at least one of the multiple cipher engines, a random number generator for generating identifying numbers to choose sub-key tables, and a checksum engine positioned prior to the last cipher engine, the checksum engine adapted to produce a checksum value for insertion into the input data stream of the last cipher engine.

One of the main flaws of modem cipher technologies is that the same key table is used to encrypt every block of text of the regular input. If this cipher is broken, then not only does the entire encrypted text file become vulnerable, but all encrypted text files created with that key table also become vulnerable. As a result, such system contain an inherent vulnerability that cannot be overcome by simply increasing the complexity of a cipher engine and key table.

Unlike prior art encryption systems, the present invention varies the key table used for encryption from message to message and from line to line within the message on a totally random basis. This greatly improves the complexity of the cipher and provides minimal options, if any, for attackers trying to penetrate the system.

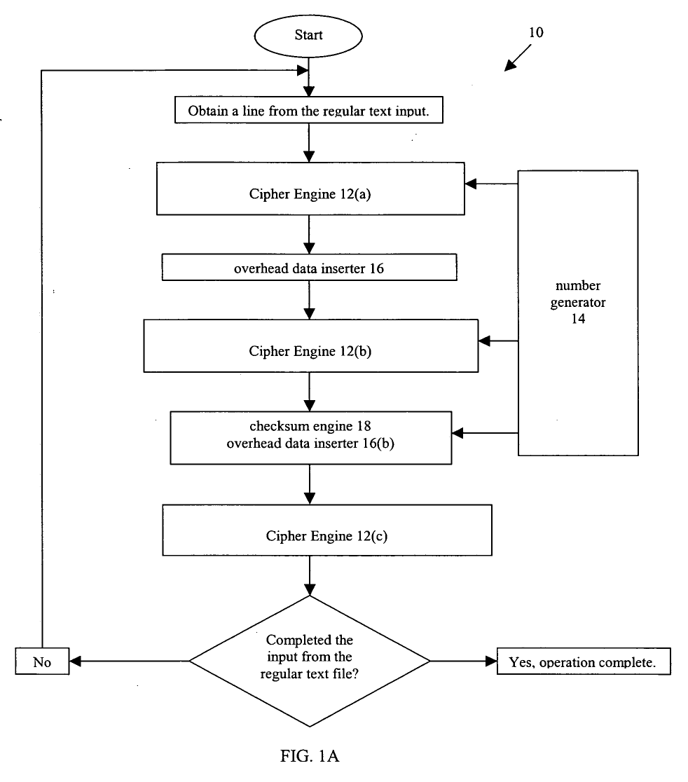

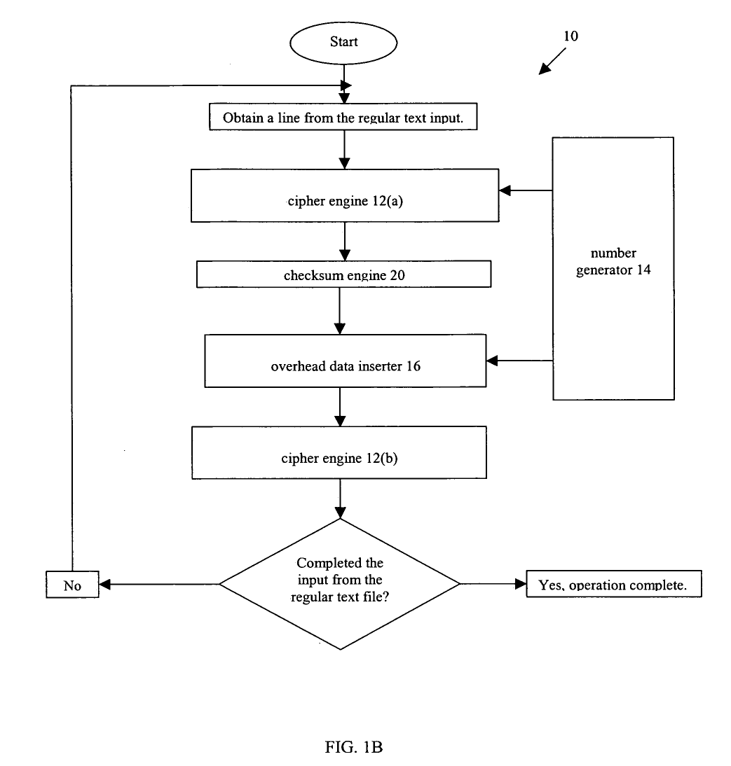

FIG. 1A illustrates one exemplary embodiment of the encryption system 10 of the present invention having three cipher engines 12(a), 12(b), and 12(c) in series. The cipher engines can run any cipher algorithm, and one skilled in the art will appreciate that numerous cipher algorithms of various strengths and complexities that are available. In one non-limiting example, the first cipher engine could be a limited version of the Vernam Cipher, the second cipher engine could be the AES cipher, and third cipher engine could be the Transposition Cipher.

The cipher engines execute their functions using a sub-key table chosen randomly from a group of sub-key tables. Preferably, groups of sub-key tables are organized into sections and each cipher engine uses a sub-key table from its respective section. Any number of sub-key tables can make up a section of sub-key tables. For illustrative purposes 1,024 fixed sub-key tables for each engine will be used to describe the exemplary cryptographic system.

Each sub-key table in each section is associated with a number. When a sub-key table is needed, one of the sub-key tables is selected by randomly choosing one of the associated numbers. For example, to encrypt the input data stream to the first cipher engine 12(a) a number generator 14 can select a number and thereby choose one of 1,024 fixed sub-key tables. The cipher engine then uses the chosen sub-key table to encrypt the input data.

A person skilled in the art will appreciate that a variety of number generators are available for selecting numbers and sub-key tables. In one embodiment, number generator 14 is a random number generator. For example, a hardware random number generator from the ComScire Company in Roswell, N.Mex. could be used. In addition, pseudo random number generators could be used. One skilled in the art will appreciate that any sort of number generator could be used, however, the protection ability of this system relies on the quality of the random numbers produced by the generator. Accordingly, high quality number generators, such as those satisfying the requirements of the U.S. Government, are preferred.

Encryption system 10 of the present invention preferably also includes at least one overhead data inserter 16 position between the cipher engines 12(a), 12(b), and 12(c) in which additional information is added to the data stream. During the decryption process, this additional information is provided to the decryption engines of the decryption system for deciphering the text. As shown in FIG. 1A the overhead data inserter 16 inserts overhead information into the output data stream of cipher engine 12(a).

In one embodiment, the overhead information inserted into the output of cipher engine 12(a) by the overhead data inserter includes the number associated with the sub-key table used to encrypt input to cipher engine 12(a). In another embodiment, the data to be inserted is converted to a different number using one of the key tables prior to being inserted. In executing this embodiment, the data cannot be differentiated from the payload data by an attacker. For example, to encrypt the first line of text, a sub-key table number is generated by random number generator 14 and relayed to cipher engine 12(a) and to overhead data inserter 16. The associated sub-key table is then used by cipher engine 12(a) to encrypt the first line and the sub-key table number is inserted into the output data stream.

After encryption and insertion of the overhead information, the second engine 12(b) can execute its function on the input data stream to cipher engine 12(b) using another randomly selected sub-key table. Again, an overhead data inserter can insert the number associated with the chosen sub-key table into the output of cipher engine 12(b).

The encryption system 10 also preferably includes a checksum engine 18 positioned between the last and the second to last cipher engine. In the illustrate embodiment, the checksum engine is positioned between second engine 12(b) and third engine 12(c) and executes its function on the output data stream from cipher engine 12(b). Preferably, the checksum engine is also supplied with a random number by random number generator 14 to randomly select a sub-key table. The resulting checksum value is then inserted into the data stream between cipher engine 12(b) and cipher engine 12(c). The checksum engine will be described in more detail below.

The checksum value is preferably inserted by the overhead data inserter 16(b) positioned between cipher engine 12(b) and 12(c). A person skilled in the art will appreciate that the overhead data inserter can insert both the sub-key table number and the checksum value into the data stream. Alternatively, multiple overhead data inserters can be positioned between the next-to-last and the last cipher engines.

The third engine 12(c) then executes its function using a sub-key table, the number of the table randomly selected, from one of 1,024 fixed sub-key tables. The associated sub-key table number used to select the sub-key table for encryption engine 12(c) is not added to the output text. The output from encryption engine 12(c) provides the encrypted text for either transmission or writing to an encrypted text output file.

If additional protection is desired, more than three cipher engines can be used. For example, between any two encryption engines, additional encryption engine(s) and overhead data inserter(s) can be added.

After encrypting the first line with the last cipher engine, the process can be repeated for additional lines of text. Encrypting the second line of text works the same as the first line using the randomly selected sub-key number stored in the previous (first) line for the last cipher engine of the second line.

A person skilled in the art will appreciate that the choice of where and when to insert a specific sub-key table number can be varied. In one exemplary embodiment, instead of storing the sub-key table number for cipher engines 12(b) and 12(a) in the data stream right after each respective cipher, the sub-key table numbers for both cipher engine 12(a) and 12(b) can be inserted between 12(b) and 12(c).

In another exemplary embodiment, data inserters are positioned between each cipher engine (e.g., cipher engines 12(a) and 12(b)) and the overhead data inserter between cipher engine 12(a) and 12(b) inserts the sub-key table number that will be used by the last cipher to encrypt the next line of text (e.g., the sub-key table number used by cipher engine 12(c) to encrypt the next line). By inserting the sub-key table number for the next line between cipher engines 12(a) and 12(b), the need for an over head data inserter prior to 12(a) or after 12(c) is avoided. To explain this concept in more detail, the first line of text would be encrypted by engines 12(a), 12(b), and 12(c) using sub-key table numbers a1, b1, and c1. In order to decrypt the text, sub-key table numbers a1 and b1 are inserted by the overhead data inserter prior to encryption by cipher engine 12(c). In the next line the cipher engines 12(a), 12(b), and 12(c) encrypt the text using sub-key table numbers a2, b2, and c2. In order to insert the number c2 into the encrypted text, the data inserter between 12(a) and 12(b) preferably inserts c2 in with the first line of text between cipher engines 12(a) and 12(b). Then during the decryption process, the number c2, used for the second line, can be extracted from the first line of text and be ready for the first decipher engine for line 2.

In yet another embodiment, the first two sub-key table numbers are not inserted and the sub-key table number is inserted between cipher engines 12(b) and 12(c). The sub-key table used to encrypt the text with 12(c) is then inserted between cipher engines 12(a) and 12(b).

FIG. 1B illustrates another embodiment of the encryption system 10 including only two cipher engines. The number of cipher engines can vary and can be chosen based upon the need for encryption/decryption speed and desired level of security.

The first cipher engine's purpose is to provide immunity from any type of regular text attack. The algorithm that is chosen is preferably capable of producing what appears to be a list of random numbers whether the data is legitimate or all the same. For example, the Vernam algorithm can be used where the sub-key table values are exclusive-OR'ed to the regular text ASCII numbers. The output can be formatted into a hex data string that is of the customer's selection (it processes 96 characters, 3 blocks of 32 characters each, 2 hex digits per character for a total of 192 hex digits)

The second (or last) cipher engine's purpose is to provide the main security complication for this system. For example, the Advanced Encryption Standard (“AES”) engine. The third cipher (or second if only two are used) can hide the output of the main or previous cipher engine. It can also hide the checksum, inserted in the line prior to the execution of the third cipher engine from being correctly determined through any type of calculated methodology by an attacker.

One skilled in the art will appreciate a variety of alternative embodiments for increasing the complexity of the system. For example, the starting point in the key table for the cipher engines can be randomly selected and/or the direction of access to the key table can be randomized or selected in a round-robin fashion. Such a modification could, for example, be used with both the Vernam and the Transposition Cipher Engines. The Vernam cipher, with 1,023 sub-keys of 95 random numbers in each in memory, provides a total of 97,280 different usable keys; and with 1,024 sub-keys of 222 random numbers in each in memory, 454,656 different keys are available.

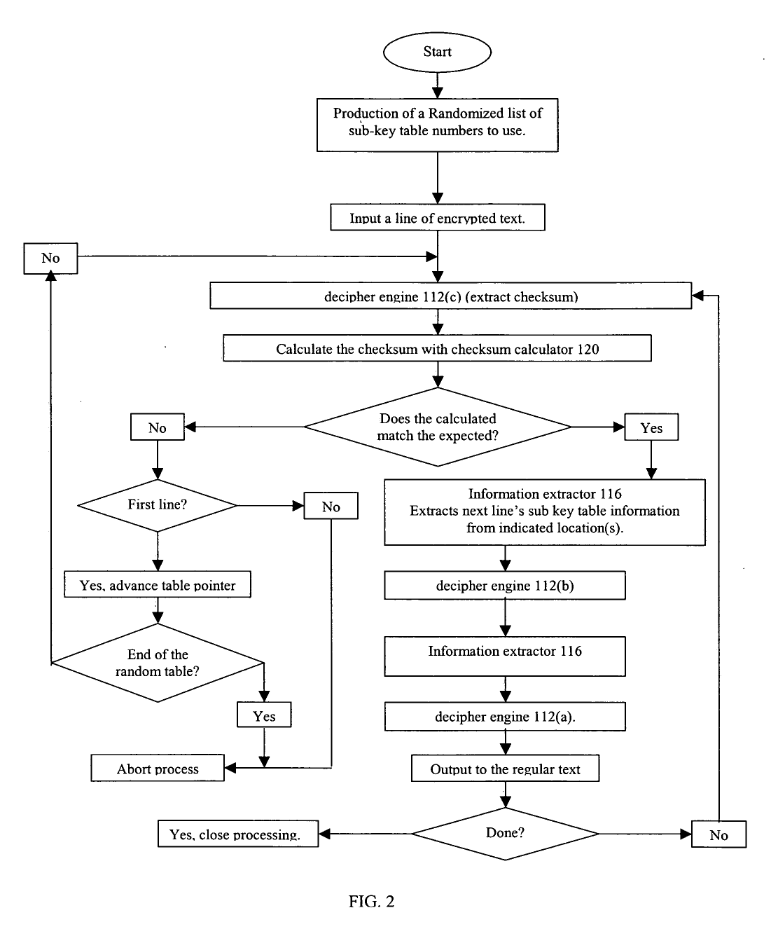

The decryption system of the present invention preferably includes serially arranged decipher engines as shown in FIG. 2. Preferably, the decipher engines correspond to the cipher engines of the encryption system and that are arranged in the reverse order. For example, the first decipher engine 112(c) preferably corresponds to the cipher engine 12(c) and is adapted to decipher output data from the cipher engine 12(c) given the proper sub-key table number. The decryption system also preferably includes groups of sub-key tables associated with each decipher engine. The sub-key tables are the same as those used with the encryption system and are numbered in the same order.

Decryption begins by feeding the encrypted text to the decryption system 100. Since the sub-key table number necessary to decrypt the first line with the first decipher engine 112(c) is not enclosed in the encrypted text, the decryption system begins by randomly selecting one of the sub-key tables and attempting to decrypt the encrypted text using engine 112(c). The expected checksum is extracted from the output of the decipher engine 112(c). The checksum calculator 120 calculates the checksum of the line after the expected checksum digits are extracted. If the calculated sum matches the extracted expected sum, then the correct sub-key table was chosen. If however, the calculated sum does not match, then a second sub-key table is randomly selected and used to decrypt the first line of text with the first decipher engine 112(c). This process is repeated without reusing any sub-key numbers until the check sum matches the extracted expected value, indicating that the correct sub-key was chosen.

Once the correct sub-key table is found for engine 112(c) and the first line is deciphered with the first cipher engine, the sub-key table numbers for decipher engines 112(b) and 112(a) can be extracted with information extractor 116. These sub-key table numbers can then be used to decrypt the first line using decipher engines 112(b) and 112(a). After deciphering with decipher engine 112(b), a second information extractor 116 preferably extracts the sub-key table number for deciphering the next line of text using the first decipher engine 112(c). After decipher engine 112(a) processes the data stream, the first line is then fully decrypted (for a three cipher engine cipher system).

The process can be repeated for the second line of text. However, in an alternative embodiment, the sub-key table number for deciphering the second line of text with the first decipher engine 112(c) is stored in the first line and is extracted by one of the information extractors 116. The extracted sub-key table number can then be used to decipher the second line with the first cipher engine 112(c). The remaining sub-key table numbers are then extracted and used in the associated decipher engines to completely decipher the second line of text. Consecutive lines of text are then deciphered until the whole text is completely deciphered.

As described above the checksum value provides a way for the decrypt cipher to determine if the correct key table was selected. It can also provide the capability for the legitimate receiver to know, through the error-free execution of the decrypt operation of this system that the encrypted text arrived in the same form that was produced prior to transmission. One of skill in the art will appreciate that a variety of checksum engines could be used to provide the checksum. Exemplary checksum engines may provide a way to define or calculate a mathematical ‘picture’ of the individual digits and the position of the digits in the data stream. In one non-limiting example, the line of numbers to be checksumed is fed to a special program loop that observes 3 sequential numbers in the line at a time, a ‘sliding window’ into the line of numbers. It uses these 3 numbers to reference into a randomly created checksum table, and the number in that position in the table is added to a checksum accumulator. The loop advances by 1, and the next set of 3 numbers is used to reference the same table. Example: take the string of digits ‘123456’. The first set of 3 numbers ‘123’ is used to reference table location 123 that might, for example, contain 5,387. The next set, ‘234’ would reference table location 234 that would contain, for example, 295. ‘345’ would reference location 345 containing 3,978, continuing the process to the end of the line. A person skilled in the art will appreciate that merely reversing two digits (no alterations) will alter 3 of the table references causing unpredictable and usually drastic changes and ultimate failure in the checksum so calculated.

In one embodiment for the overhead data inserter 16(b), take the example of inserting the string ‘935745’ within the payload string. One of the random numbers obtained at the start of the encryption process is used to select one of 1,024 lists of random numbers in the key table specifically allocated for the data inserter. Suppose table 408 was selected containing random numbers 35, 183, 105, 55, 92 and 172. The first digit, ‘9’, is inserted in the line at position 35, moving the remaining numbers down the string to make room. The second digit, ‘3’ is placed at position 183, again moving the remaining numbers down. The next digits, ‘5’, ‘7’, ‘4’ and ‘5’ are placed in positions 105, 55, 92 and 172 respectively. Within the decrypt process, the are extracted from the string in reverse order to ensure the payload digits remain in tact.

One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirely.

What is claimed is:

1. An encryption system, comprising:
multiple sub-key tables, each sub-key table associated with an identifying number;
multiple cipher engines arranged serially, each cipher engine capable of executing a different encryption operation on an input data stream using a sub-key table and producing an output data stream;
an overhead data inserter for inserting deciphering data into the output data stream of at least one of the multiple cipher engines;
a number generator for generating identifying numbers to choose sub-key tables; and
a checksum engine adapted to produce a checksum value for insertion into the input data stream of the last cipher engine.

2. The system of claim 1, wherein the number generator is a random number generator adapted to randomly select numbers.

3. The system of claim 2, wherein the random number generator is hardware based.

4. The system of claim 1, wherein the checksum engine is positioned prior to the last cipher engine.

5. The system of claim 1, wherein the data inserted by the overhead data inserter includes numbers chosen by the number generator.

6. The system of claim 1, wherein the data inserted by the overhead data inserter includes the checksum value produced by the checksum engine.

7. The system of claim 1, wherein an overhead data inserter is positioned between each cipher engine.

8. The system of claim 1, including one set of sub-key tables for each cipher engine.

9. The system of claim 1, including multiple decipher engines arranged serially for deciphering the output from the final cipher engine.

10. The system of claim 9, including a checksum deciphering engine, the deciphering engines and checksum deciphering engine positioned in the reverse sequence of the encryption cipher engines and checksum engine.

11. The system of claim 1, wherein the system includes three cipher engines.

12. The system of claim 1, wherein the sub-key tables, multiple cipher engines, number generator, and overhead data inserter are stored in a computer readable format.

13. The system of claim 12, wherein the computer-readable format is stored in a non-volatile memory device executable by a Command Processor Unit.

14. A method of encrypting data, comprising:
providing multiple sub-key tables;
providing multiple cipher engines arranged serially, each cipher engine capable of executing an encryption operation on a data stream using a sub-key table and producing an output data stream;
choosing a sub-key table for encrypting the first line of the data stream with the first cipher engine;
encrypting the first line of the data stream with the first cipher engine;
inserting data into the data stream identifying one of the multiple sub-key tables;
performing a checksum operation on data stream; and
inserting checksum data into the data stream.

15. The method of claim 14, wherein the step of inserting data includes inserting data into the output from the first cipher engine that identifies the sub-key table used to encrypt the input to the first cipher engine.

16. The method of claim 14, wherein the step of inserting data includes inserting data into the output from the first cipher engine that indicates the sub-key table that will be used to encrypt the input to the last cipher engine of the next line.

17. The system of claim 14, wherein a random number generator selects a number used to chose the sub-key table for encrypting the first line of the input data stream with the first cipher engine.

18. The system of claim 17, wherein the number used to randomly choose the sub-key table is added to the data stream by an overhead data inserter.

19. The system of claim 14, wherein an encrypted data stream is decrypted.

20. A method of decrypting data, comprising:
providing an encrypted input data stream encrypted by cipher engines in series;
providing multiple sub-key tables;
providing multiple decipher engines arranged serially, each cipher engine capable of executing a-different encryption operation on an input data stream using a sub-key table and
producing an output data stream;
choosing one of the multiple sub-key tables;
inputting the chosen sub-key table into the first decipher engine;
deciphering the encrypted data stream with the first decipher engine;
extracting a checksum value from the output data of the first decipher engine; and
using the checksum value to determine if the correct sub-key table was chosen.

21. The method of claim 20, wherein the extracted checksum value is compared to a calculated checksum.

22. The method of claim 20, wherein the correct sub-key table was chosen if the extracted checksum matches the calculated checksum and the incorrect sub-key table was chosen if the extracted checksum fails to match the calculated checksum.

23. The method of claim 20, wherein the incorrect sub-key table was chosen and the method further includes,
choosing different sub-key table;
inputting the chosen sub-key table into the first decipher engine;
deciphering the encrypted data stream with the first decipher engine;
extracting a checksum value from the output of the first decipher engine; and
using the checksum value to determine if the correct sub-key table was chosen.

24. The method of claim 20, wherein the correct sub-key table was chosen and the method further comprises extracting a number from the output to the first decipher engine.

25. The method of claim 24, wherein the extracted number is used to determine which sub-key table should be used with the second decipher engine.

26. The method of claim 25, further comprising deciphering the output data stream from the first decipher engine with the second decipher engine.
